(19) United States
(12) Patent Application Publication
(10) Pub. No.: US 2026/0031744 A1
(43) Pub. Date: Jan. 29, 2026

(54) Power Converter With Auxiliary Voltage Supply

(71) Applicant: Siemens Aktiengesellschaft, München (DE)

(72) Inventors: Siegmar Unterweger, München (DE); Young Hun Lee, Baldham (DE)

(73) Assignee: Siemens Aktiengesellschaft, München (DE)

(21) Appl. No.: 19/275,135

(22) Filed: Jul. 21, 2025

(30) Foreign Application Priority Data
Jul. 23, 2024 (DE) 10 2024 206 907.8

(51) Int. Cl. H02M 7/219; H02M 1/00; H02M 1/10; H02M 1/44; H02M 7/217

(52) U.S. Cl. CPC H02M 7/219; H02M 1/0006; H02M 1/10; H02M 1/44; H02M 7/2176

(57) ABSTRACT

A power converter includes: a first rectifier with a plurality of controllable power semiconductor switches; a first DC link connected to the DC voltage side of the first rectifier; a controller for the power semiconductor switches; a second DC link; a DC voltage converter with an input side connected to the second DC link to reduce the voltage applied to the second DC link, wherein an output side of the DC voltage converter is connected to supply terminals of the controller; a connection between upper poles of the first DC link and the second DC link and a connection between the lower poles; a first diode in a first of the two connections; and a second rectifier including a passive rectifier with a DC voltage side connected to the second DC link and an AC side connected to an AC voltage side of the first rectifier.

### CROSS-REFERENCE TO RELATED APPLICATIONS

This application claims priority to DE Application No. 10 2024 206 907.8 filed Jul. 23, 2024, the contents of which are hereby incorporated by reference in their entirety.

### TECHNICAL FIELD

The present disclosure relates to power converters. Various embodiments of the teachings herein include a bidirectional power converter for converting a first voltage to a second voltage.

### BACKGROUND

Standards that prescribe behavior of a converter apply to converters that feed into the grid. One of these standards relates to so-called UVRT (under voltage ride through). For this, the regulations state that the converter must remain connected to the grid even if the grid voltage drops and, as soon as the grid voltage is back within the limits, feeds back into the grid. However, if the grid voltage is too low, the control unit of the converter will also fail. One problem that arises here is thus the supply to the control unit in the event of a grid fault.

A known solution is the installation of two auxiliary supplies. A first auxiliary supply is used for start-up from the grid. A second auxiliary supply is supplied from the DC link of the converter. In the case of PV inverters, the second auxiliary supply can also be fed from the PV side. The disadvantage of the known solutions is that they add some complexity and installation size to a bidirectional power converter in order to comply with standards.

### SUMMARY

The teachings of the present disclosure include bidirectional power converters in which the disadvantages mentioned at the beginning are avoided. For example, some embodiments include a power converter (10, 50) for converting a first voltage to a second voltage, having: a first rectifier (14) having a plurality of controllable power semiconductor switches, a first DC link (16) connected to the DC voltage side of the first rectifier (14), a controller (20) for the power semiconductor switches, a second DC link (26), a DC voltage converter (30) connected on the input side to the second DC link (26) and configured to reduce the voltage applied to the second DC link (26), wherein the DC voltage converter (30) is connected on the output side to supply terminals (21) of the controller (20), a connection between the upper poles of the first and second DC links (16, 26), a connection between the lower poles of the first and second DC links (16, 26), a first diode (28A) in a first of the two connections, and a second rectifier (24) which is a passive rectifier and the DC voltage side of which is connected to the second DC link (26) and the AC side of which is connected to the AC voltage side of the first rectifier (14).

In some embodiments, the first diode (28A) is arranged so as to block a current flow from the second to the first DC link (16, 26).

In some embodiments, the second rectifier (24) is a three-phase diode bridge (24) and comprises at least 6 diodes.

In some embodiments, the second rectifier is a single-phase diode bridge and comprises 4 diodes.

In some embodiments, the second rectifier is connected on the input side to a neutral conductor.

In some embodiments, the power converter (10, 50) includes a second diode (28B) in a second of the two connections.

In some embodiments, the second diode (28B) is arranged so as to block a current flow from the second to the first DC link (16, 26).

In some embodiments, the power converter (10, 50) is configured for connection to a three-phase supply voltage (8) as the first voltage.

In some embodiments, the first rectifier (14) is connected on the AC voltage side to an EMC filter (12).

In some embodiments, the second rectifier (24) is connected on the AC voltage side between the EMC filter (12) and the first rectifier (14).

In some embodiments, the power converter (10, 50) includes a switching device between the first rectifier (14) and the EMC filter (12).

### BRIEF DESCRIPTION OF THE DRAWINGS

The teachings of t disclosure are described and elucidated in detail hereinafter by the exemplary embodiments shown in the figures. In the figures:

FIG. 1 shows a first example power converter incorporating teachings of the present disclosure and having a controller and an auxiliary power supply for the controller; and

FIG. 2 shows a second example power converter incorporating teachings of the present disclosure and having a controller and an auxiliary power supply for the controller.

### DETAILED DESCRIPTION

Some embodiments of the teachings herein include a power converter configured for converting a first voltage to a second voltage. One example comprises a first rectifier having a plurality of controllable power semiconductor switches, a first DC link connected to the DC voltage side of the first rectifier and a controller for the power semiconductor switches. It further comprises a second DC link, a DC voltage converter connected on the input side to the second DC link and configured to reduce the voltage applied to the second DC link, wherein the DC voltage converter is connected on the output side to supply terminals of the controller. It further comprises a connection between the upper poles of the first and second DC links and a connection between the lower poles of the first and second DC links, wherein a first diode is arranged in a first of the two connections. Finally, the example power converter comprises a second rectifier which is a passive rectifier and the DC voltage side of which is connected to the second DC link and the AC side of which is connected to the AC voltage side of the first rectifier.

In some embodiments, the first voltage is a grid voltage connected to the power converter, for example a three-phase 400 V grid.

The power converters described herein combine the two supplies for the controller from the grid and from the DC link. For this purpose, the DC voltage converter, e.g. a flyback converter, is decoupled from the DC link by the first diode and a separate DC link, the second DC link, is generated.

In standby mode, this may be supplied from the grid, that is to say by the first voltage. In active mode of the power converter, the DC link voltage is greater than the rectified grid voltage and the DC voltage converter is fed from the DC link.

Potential configurations of the power converter proceed from the dependent claims. In this case, the embodiment of the independent claims can be combined with the features of one of the dependent claims or with those from a plurality of dependent claims. Accordingly, the following features can also be additionally provided:

In some embodiments, the first diode is arranged so as to block a current flow from the second to the first DC link. In other words, only one power flow to the DC voltage converter is permitted.

In some embodiments, the second rectifier comprises a three-phase diode bridge. As is generally known, this comprises six diodes, which are arranged in the manner of three parallel half-bridges.

In some embodiments, the second rectifier may be a single-phase diode bridge having 4 diodes. In this case, one of the AC voltage inputs of the diode bridge may be connected to a neutral conductor of the power converter, while the other AC voltage input is connected to one of the three phases.

In some embodiments, there is a second diode in a second of the two connections. In other words, a diode or a series of diodes is in each of both connections, wherein both diodes are arranged in such a way that they act so as to block a current flow from the second to the first DC link.

In some embodiments, the power converter is configured for connection to a three-phase supply voltage as the first voltage. The first rectifier may be connected on the AC voltage side to an EMC filter, which in turn is connected to the first voltage, that is to say the supply network. The second rectifier may be connected on the AC voltage side between the EMC filter and the first rectifier.

In some embodiments, the power converter may have a switching device between the first rectifier and the EMC filter, in particular a mechanical switch for isolation from the supply network. The second rectifier may then be connected on the AC voltage side between the EMC filter and the switch.

When the present text refers to individual components such as diodes or power semiconductor switches, for example, then this can also always mean a series circuit of multiple such components. A series circuit can be used to adjust to the actual maximum voltage in this case.

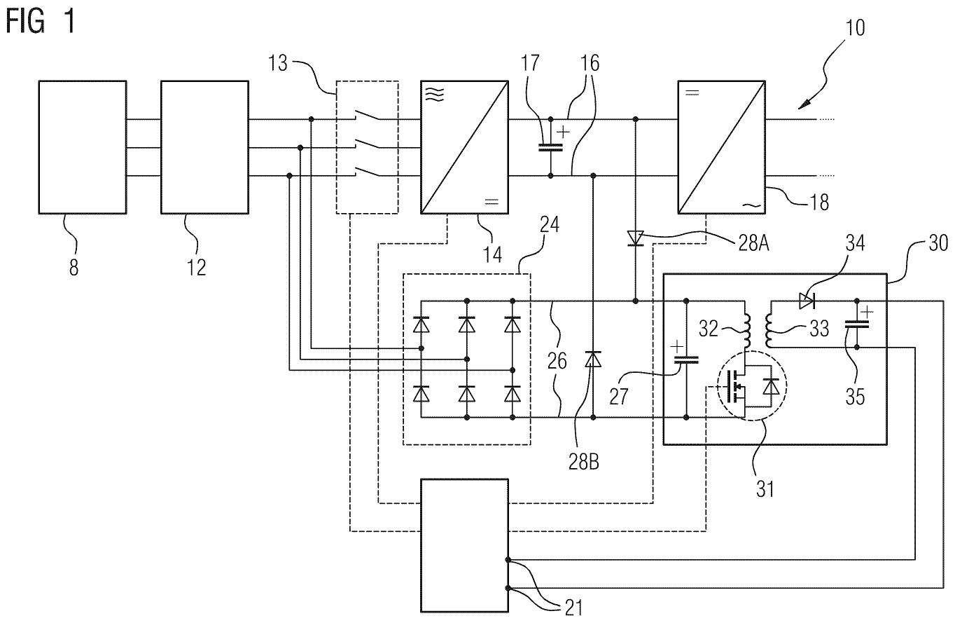

FIG. 1 shows an example power converter 10 incorporating teachings of the present disclosure. The power converter 10 is connected to a three-phase supply network 8. It comprises an EMC filter 12, a first rectifier 14 (also referred to as power factor correction, PFC), a first DC link 16, and an output power converter.

The EMC filter 12, the first rectifier 14 and the output power converter 18 are not shown in detail. Possible structures for this are known from the prior art. For example, the rectifier 14 may comprise three parallel-connected half-bridges each having two or more series power semiconductor switches, for example IGBTs or MOSFETs, the outer terminals of which are connected to the first DC link 16.

For example, the output power converter may be an inverter 18. The inverter may have the same structure as the rectifier 14. An inverter which performs a reverse transformation from the first DC link 16 to a three-phase AC voltage can be used, for example, to operate an electric motor.

However, the output power converter may also comprise, for example, a DC/DC converter. This can be used, for example, for galvanic isolation and/or changing of the voltage level. Such a structure can be used, for example, to implement a DC charging station for the wired charging of an electric vehicle.

In this exemplary embodiment, the output power converter is an inverter 18 having a single-phase output. An inverter of this type can, for example, supply the power for a coil that forms the base element of a device for wired or wireless charging of an electric vehicle.

The EMC filter 12 is directly connected to the supply network 8. A switch 13 for disconnecting the electrical connection is arranged between the rectifier 14 and the EMC filter 12. The DC link 16 is arranged between the rectifier 14 and the output power converter 18 and comprises one or more series capacitors 17.

The power converter 10 further comprises a controller 20 which generates control signals for the power semiconductor switches present and is expediently connected to the gate driver circuits for the switches. The controller comprises supply terminals 21 for a supply voltage, using which the internal components of the controller, such as a microcontroller, for example, are operated and control signals are generated. It is well known that such a supply voltage must be in a voltage range of roughly between 1 V and 50 V. Example values for a supply voltage are 5 V, 12 V, 24 V or 48 V. Thus, the supply voltage is far away from the typical DC link voltages of, for example, 650 V, 800 V, 1000 V or more.

To provide the supply voltage, the power converter 10 comprises additional components. A second rectifier 24 is connected between the EMC filter 12 and the switch 13. The second rectifier 24 is a diode bridge rectifier comprising six diodes connected in the manner of parallel half-bridges. The second) rectifier 24 is connected at its DC voltage side output to a second DC link 26. The second DC link 26 comprises one or more DC link capacitors 27.

The second DC link 26 is still connected by way of its poles to the corresponding poles of the DC link 16. A diode 28A, B is present in each of the two connections. The diodes 28A, B are arranged in such a way that they block a current flow from the second DC link 26 to the DC link 16. In other words, the diodes 28A, B allow the second DC link 26 to be charged from the DC link 16, but not vice versa.

The second DC link 26 is still connected to the input side of a flyback converter 30. On the input side, the flyback converter 30 comprises a series circuit of a controllable power semiconductor switch 31 and a coil 32 as the primary side of a transformer. On the output side, the flyback converter 30 comprises a circuit consisting of a coil 33 as the secondary side of the transformer, a diode 34 for rectification and a smoothing capacitor 35, to the terminals of which the output voltage is applied. These terminals are connected to the supply terminals 21 of the controller 20.

Since the voltage in the second DC link 26 essentially corresponds to that in the DC link 16, the components of the flyback converter 30 are designed for a corresponding voltage. In particular, the power semiconductor switch 31 has a suitable reverse voltage. The diodes of the second rectifier 24 can also each be formed by a series circuit of multiple diodes. Similarly, the diodes 28A, B can each be formed by a series circuit of multiple diodes.

If the power converter 10 is in standby, then the second DC link 26 is fed from the grid. In active mode of the power converter 10, the voltage in the DC link 16 is greater than the rectified grid voltage and the flyback converter 30 is fed from the DC link 16.

If the grid voltage fails, then the energy required for the operation of the controller 20 can continue to be taken from the DC link 16 for a certain time.

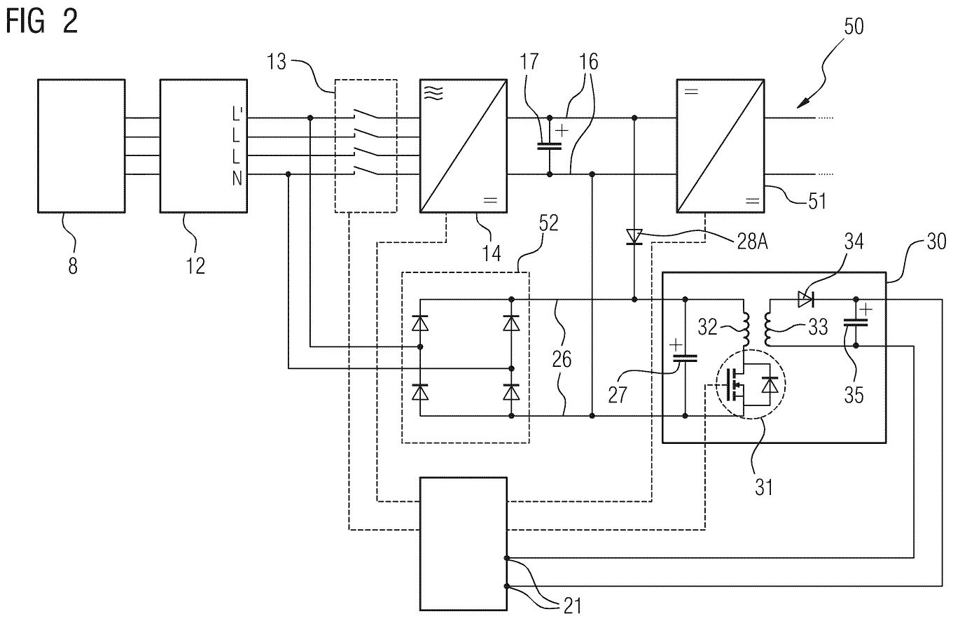

FIG. 2 shows a second example power converter incorporating teachings of the present disclosure. The power converter 50 largely corresponds to the power converter 10 of FIG. 1. The differences are shown below.

On the output side, the power converter 50 comprises a DC/DC converter 51 instead of the inverter 18.

In addition, the diode 28B is omitted from the power converter 50. In other words, there is thus a direct connection between the negative poles of the two DC links 16, 26. The diode 28A also ensures that the second DC link 26 is not discharged with respect to the DC link 16. This change shifts the DC link potential of the converter.

Finally, in the power converter 50, the second rectifier 24 is replaced by a single-phase bridge rectifier 52 having four diodes. The bridge rectifier 52 is expediently connected to the neutral conductor N, which must be present for this purpose in the power converter 50.

The three described changes to the power converter 10 are independent of one another and may not be present at all, individually or in combination in different configurations of a power converter as described herein.

### REFERENCE SIGNS

8 Power supply network
10, 50 Power converter
12 EMC filter
13 Switch
14 First rectifier
16, 26 DC link
17, 27 DC link capacitor
18 Inverter
20 Controller
21 Supply contacts
24 Three-phase bridge rectifier
28A, B Diode
30 Flyback converter
31 Power semiconductor switch
32, 33 Primary/secondary coil
34 Rectifier diode
35 Smoothing capacitor
51 DC/DC converter
52 Single-phase bridge rectifier
N Neutral conductor

1. A power converter for converting a first voltage to a second voltage, the power converter comprising:
a first rectifier with a plurality of controllable power semiconductor switches,
a first DC link connected to the DC voltage side of the first rectifier;
a controller for the power semiconductor switches;
a second DC link;
a DC voltage converter with an input side connected to the second DC link to reduce the voltage applied to the second DC link, wherein an output side of the DC voltage converter is connected to supply terminals of the controller;
a connection between upper poles of the first DC link and the second DC link;
a connection between lower poles of the first DC link and the second DC link;
a first diode in a first of the two connections; and
a second rectifier including a passive rectifier with a DC voltage side connected to the second DC link and an AC side connected to an AC voltage side of the first rectifier.

2. The power converter as claimed in claim 1, wherein the first diode blocks a current flow from the second DC link to the first DC link.

3. The power converter as claimed in claim 1, wherein the second rectifier comprises a three-phase diode bridge and at least 6 diodes.

4. The power converter as claimed in claim 1, wherein the second rectifier comprises a single-phase diode bridge with 4 diodes.

5. The power converter as claimed in claim 4, wherein an input side of the second rectifier is to a neutral conductor.

6. The power converter as claimed in claim 1, further comprising a second diode in a second of the two connections.

7. The power converter as claimed in claim 6, wherein the second diode blocks a current flow from the second DC link to the first DC link.

8. The power converter as claimed in claim 1, wherein the power converter is configured for connection to a three-phase supply voltage as the first voltage.

9. The power converter as claimed in claim 1, wherein an AC voltage side of the first rectifier to an EMC filter.

10. The power converter as claimed in claim 9, wherein an AC voltage side of the second rectifier is connected between the EMC filter and the first rectifier.

11. The power converter as claimed in claim 9, further comprising a switching device between the first rectifier and the EMC filter.
